(19) United States
(12) Patent Application Publication
(10) Pub. No.: US 2006/0284930 A1
(43) Pub. Date: Dec. 21, 2006

(54) Methods and arrangements for adjusting and aligning fluid dispensing devices and the like such as continuous ink jet printheads

(76) Inventors: George Mejalli, Pittsburgh, PA (US); Ralph M. Chew, New Kensington, PA (US); Sean R. O'Leary, Glenshaw, PA (US); Marlin H. Mickle, Pittsburgh, PA (US); James MaCpherson, Monongahela, PA (US); Frank Marx, Pittsburgh, PA (US); John Andrew Holmes, Wexford, PA (US)

Correspondence Address: Ian K. Samways;Reed Smith LLP, P.O. Box 488, Pittsburgh, PA, 15230-0488, US

(21) Appl. No.: 11/158,312

(22) Filed: Jun. 21, 2005

(51) Int. Cl. B41J 2/16

(52) U.S. Cl. 347/47

(57) ABSTRACT

Methods and arrangements for adjusting and maintaining a lateral or radial position of a nozzle such as a nozzle in an ink jet print head. Since the alignment of an ink stream issuing from a nozzle in ink jet applications is usually critical in that the ink jet stream must be directed to a specific target area, described herein are arrangements for enabling the nozzle and issuing ink stream to be precisely aligned for calibration and maintenance purposes. In addition the adjustment is simplified and once made it stays in position. Similar principles can be applied to other types of nozzles and arrangements wherein another type of fluid, or even light, is issued out.

### CROSS-REFERENCE TO RELATED U.S. APPLICATION

This application claims priority under 35 U.S.C. 119(e) from U.S. Provisional Patent Application Ser. No. 60/581,096, filed on Jun. 18, 2004.

### FIELD OF THE INVENTION

The present invention generally relates to fluid dispensing devices such as continuous ink jet printers and printheads, or alternatively to light admitting devices and, more particularly, to methods and arrangements for adjusting the position of an ink jet stream issuing from a nozzle which is part of a print head assembly, or for adjusting the position of another type of fluid stream issuing from another type of nozzle, or for adjusting the position of a light stream issuing from a light admission aperture.

### BACKGROUND OF THE INVENTION

History has seen the development of numerous arrangements for admitting and directing ink or other fluids through a nozzle arrangement and for admitting and directing light, such as laser light, through a light admission aperture arrangement. There remains considerable room for improvement in arrangements for positionally adjusting the ink, fluid or light streams involved. Though the instant application addresses many fields of endeavor associated with such arrangements, particular problems and issues are noted herebelow in connection with “continuous ink jet” printing arrangements.

“Continuous Ink Jet” (or “CIJ”) printing has been in use for many years. Such technology normally involves a device that pressurizes ink, allows some of the ink to pass through an orifice while providing for ink flowing through the orifice to be modulated by a Lead Zirconium Titanate (PZT) diaphragm. The modulated ink stream exiting the nozzle breaks up into a stream of individual drops that appear as dots on a substrate, such as paper.

By electronically charging individual drops, it is possible to deflect individual trajectories of the drops to produce a one dimensional raster. If the substrate is moved by an independent actuator, a two dimensional raster can be printed to provide a dot matrix form of printing. Here, that by selectively charging ink drops to a certain level, or not charging them, it is possible to produce readable characters on the substrate. Such a form of printing is widely used in many industrial applications such as date coding, serial numbering, part numbering, etc., in the context of beverage cans, food package items, manufactured parts and many other items.

Normally, the printing arrangement is configured such that any drops not intended for printing on the substrate can be collected through a “gutter” and return line. In this way, the ink can be continuously flowing as opposed to being intermittently issued as in a “drop on demand” type of printing system (common to most personal computer printers). Thus the continuous flow of ink gives rise to the common name “continuous ink jet” (or CIJ).

The alignment of the continuous stream of ink drops with the gutter in a non-printing state of operation of a CIJ system is highly important. Particularly, improper alignment will cause ink to be deposited on other components of the machine itself, the substrate or anything else in the path of the ink.

CIJ nozzles are typically made from sapphire or ruby on a very small scale, with tiny holes (or orifices) having diameter on the order of several thousandths of an inch. Due to the difficulty in manufacturing such small components, the holes are often not precisely aligned. As such, alignment between an orifice for the issuing (ink jet stream) and a gutter is typically accomplished mechanically while the two items are mounted on a fixed platform or other suitable mechanism.

Indeed, various methods have been contemplated for nozzle alignment. One such method involves a nozzle mounted on the end of a tube. The tube can be bent to alter the direction of the stream of ink and align it with the gutter. An operator or field technician then aligns the orifice for the issuing (ink jet stream) and the gutter by hand until the ink properly enters the gutter for re-circulation. However, the tube here can be subject to accidental bumping and other environmental forces stimuli that can inadvertently alter the alignment. In addition, adjustment must usually be done by trial and error without regard for intuition.

In view of the foregoing, a clear need has been recognized in connection with providing improved adjustment, guidance and alignment for nozzle and/or aperture arrangements in any of a variety of settings.

### SUMMARY OF THE INVENTION

In accordance with at least one presently preferred embodiment of the present invention, there is broadly contemplated herein an improved nozzle or light admission aperture arrangement. In a preferred embodiment, a nozzle or light admission aperture can be fabricated without a tube connecting the base of the print head (or other) assembly, to an ink-issuing or fluid-issuing orifice, or to a light admission aperture.

Preferably, the fluid-issuing orifice (such as an ink-issuing orifice) is a part of a solid faceplate attached rigidly to the print head (or other) body. The faceplate contains provisions for the orifice and associated alignment screws that can be used at assembly and test time to align the orifice and the gutter. Once the orifice and gutter are aligned, no additional adjustment is required (providing there are no disturbances to the components which could render them out of alignment). Similar considerations are preferably accorded embodiments involving a light-admission aperture arrangement.

Among several advantages, calibration and field adjustments are greatly simplified. In addition, easy assembly and disassembly is afforded, along with eased replacement in the field, all without altering an initial factory calibration.

Generally, there is broadly contemplated herein, in accordance with at least one presently preferred embodiment of the present invention, in an ink delivery arrangement, a nozzle assembly comprising: a nozzle mounting arrangement; a nozzle associated with the nozzle mounting arrangement, the nozzle being configured to direct an output of ink; and an arrangement for positionally adjusting the nozzle to positionally alter the output of ink.

Additionally, there is broadly contemplated herein, in accordance with at least one presently preferred embodiment of the present invention, in a fluid delivery arrangement, a nozzle assembly comprising: a nozzle mounting arrangement; a nozzle associated with the nozzle mounting arrangement, the nozzle being configured to direct an output of fluid; and an arrangement for positionally adjusting the nozzle to positionally alter the output of fluid.

Further, there is broadly contemplated herein, in accordance with at least one presently preferred embodiment of the present invention, an ink delivery arrangement comprising: an ink source for providing ink; a nozzle assembly operably connected with the ink providing arrangement and adapted to accept ink provided by the ink source; and the nozzle assembly comprising: a nozzle mounting arrangement; a nozzle associated with the nozzle mounting arrangement, the nozzle being configured to direct an output of ink; and an arrangement for positionally adjusting the nozzle to positionally alter the output of ink.

Moreover, there is broadly contemplated herein, in accordance with at least one presently preferred embodiment of the present invention, a fluid delivery arrangement comprising: a fluid source for providing fluid; a nozzle assembly operably connected with the fluid source and adapted to accept fluid provided by the fluid source; and the nozzle assembly comprising: a nozzle mounting arrangement; a nozzle associated with the nozzle mounting arrangement, the nozzle being configured to direct an output of fluid; and an arrangement for positionally adjusting the nozzle to positionally alter the output of fluid.

Furthermore, there is broadly contemplated herein, in accordance with at least one presently preferred embodiment of the present invention, a method of delivering ink, the method comprising the steps of: providing a nozzle configured for directing an output of ink; and positionally adjusting the nozzle to positionally alter the output of ink.

Additionally, there is broadly contemplated herein, in accordance with at least one presently preferred embodiment of the present invention, a method of delivering fluid, the method comprising the steps of: providing a nozzle configured for directing an output of fluid; and positionally adjusting the nozzle to positionally alter the output of fluid.

Yet further, there is broadly contemplated herein, in accordance with at least one presently preferred embodiment of the present invention, in a light provision arrangement, an aperture assembly comprising: an arrangement for mounting a light admission aperture; an light admission aperture associated with the mounting arrangement, the light admission aperture being configured to direct an output of light; and an arrangement for positionally adjusting the light admission aperture to positionally alter the output of light.

### BRIEF DESCRIPTION OF THE DRAWINGS

FIG. 1 is an exploded view of a nozzle assembly and base.

FIG. 2 is an exploded view of a nozzle assembly.

FIGS. 3a-3c respectfully provide plan, elevational and cross sectional views of a nozzle.

FIG. 4 is a perspective view of a nozzle assembly.

FIG. 5 is a cross sectional view of a nozzle assembly.

FIG. 6 illustrates in perspective view a method of nozzle adjustment.

FIG. 7 schematically illustrates a general fluid or light dispensing device and components.

### DESCRIPTION OF THE PREFERRED EMBODIMENTS

Various embodiments of the present invention are directed to the admission and direction of ink or other fluids through a nozzle arrangement or to the admission and direction of light, such as laser light, through a light admission aperture arrangement. The disclosure turns at present to a discussion of a continuous ink jet print head arrangement, though it is to be understood that similar principles may be readily applied to arrangements involving fluids other than ink, or even to arrangements involving light, such as laser light.

The terms “fluid” and “fluids”, as generally employed herein, may be generally regarded as relating to a wide range of liquids, gases, plasmas, particulate streams and even, to some extent, plastics and solids, as generally understood and appreciated in the general engineering arts.

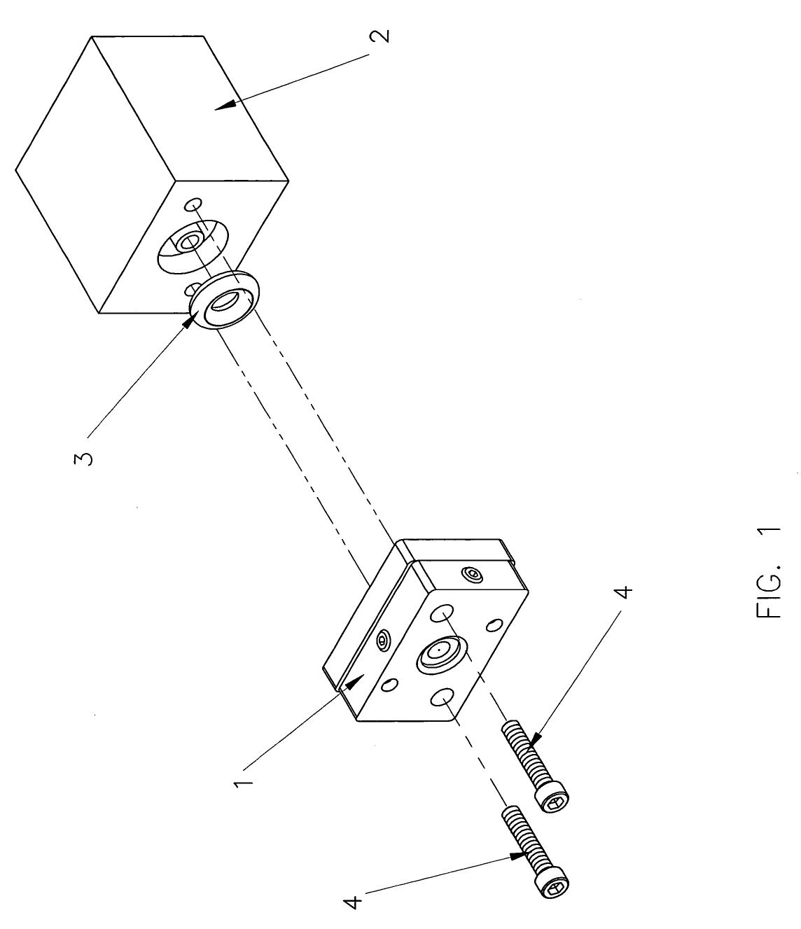

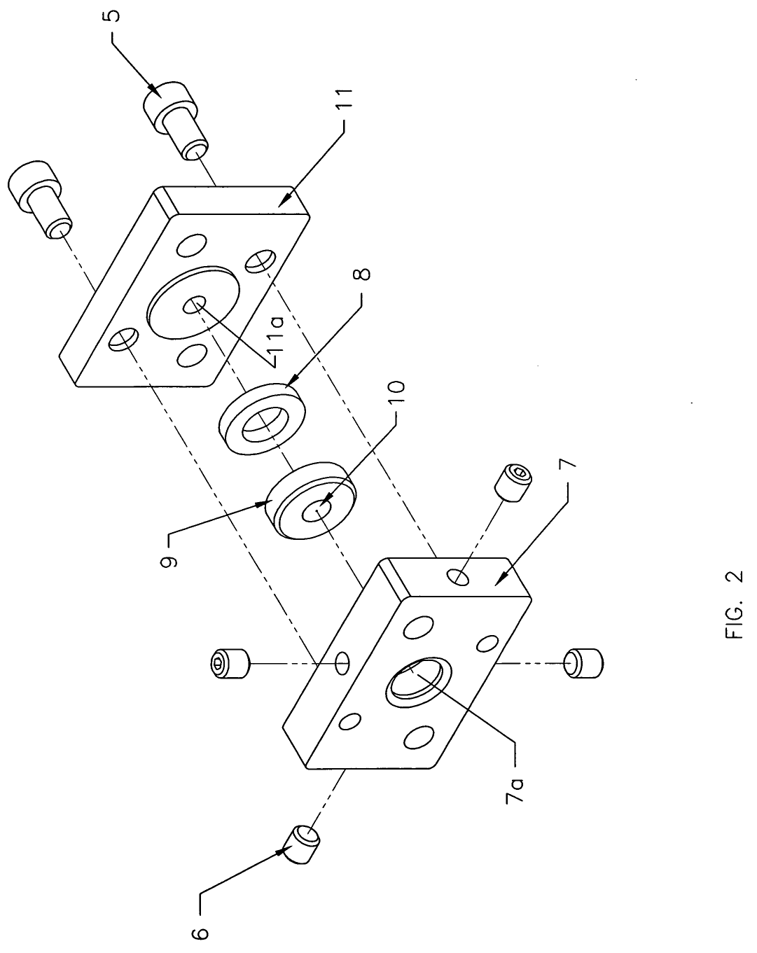

As shown in FIG. 1, a print head may include a nozzle assembly 1 mounted to a print head base 2 with two screws 4. An O-ring 3 seals against leakage of pressurized and modulated ink passing from the print head base 2 to the nozzle assembly 1. The nozzle assembly includes nozzle end cover 7 (as shown in FIG. 2) and a nozzle body 9 with a boss (not visible) on one end over which a sealing ring 8 is located. The nozzle 9 with sealing ring 8 preferably fit into a counterbore in the nozzle cover 7 (not fully visible in the drawing). The nozzle cover 7 preferably has a hole 7a drilled through its center to permit throughput of a stream of ink droplets issuing from the nozzle.

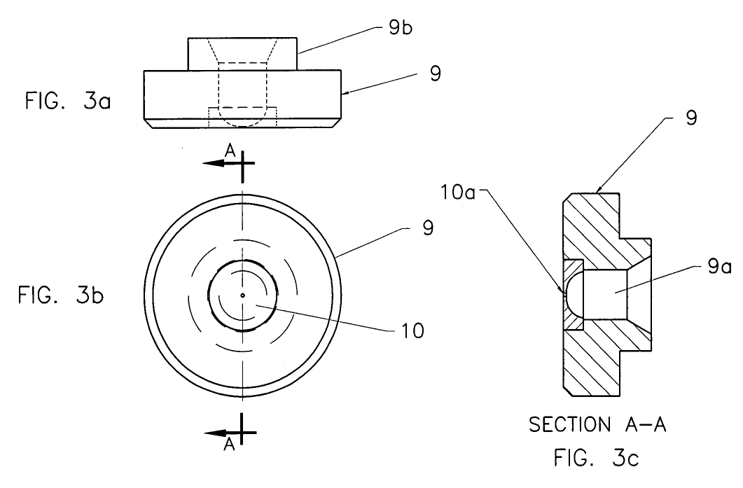

Per convention, the ink droplets can be formed as a result of the action of a Lead Zirconium Titanate (PZT) diaphragm (part of the base 2) which controls the natural modulation of the ink stream and its breakup into droplets. As seen in FIGS. 2 and 3a-3c, the nozzle body 9 with a ruby or sapphire disk 10 (with orifice 10a) pressed in place in a counterbore at one end. A hole 9a drilled through the center of the body 9 allows passage of ink through the body 9 to the orifice 10. On the opposite end is the boss 9b for the sealing ring 8 (see FIG. 2). A nozzle back plate 11 (as shown in FIG. 2) preferably attaches to the nozzle end cover 7 with two screws 5. The nozzle back plate 11 has a hole 11a drilled through its center to allow pressurized ink to pass from the base 2 to the nozzle assembly 1 (as shown in FIG. 1).

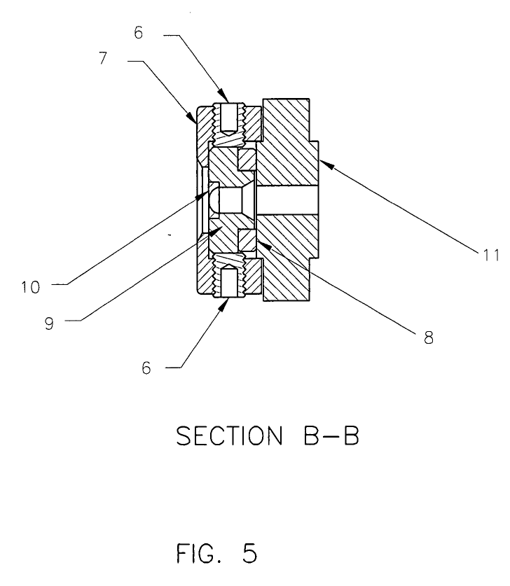

The nozzle 9 and sealing ring 8 are preferably “trapped” in the counter bore between cover 7 and plate 11 (as shown in FIG. 2 or in cross section in FIG. 5). The sealing ring 8 is preferably of an elastomeric material and of such thickness that it is compressed when the assembly is complete. The compression of the seal 8 prevents leaking of the ink as it passes through the nozzle assembly but it is not great enough to prevent the nozzle and seal from moving or sliding laterally on their own within the pocket created by the counterbore 7a of the nozzle cover 7. (The counterbore 7a in the nozzle end cover 7 is larger in diameter than the diameter of the nozzle 9, allowing the nozzle to move about within the counterbore.)

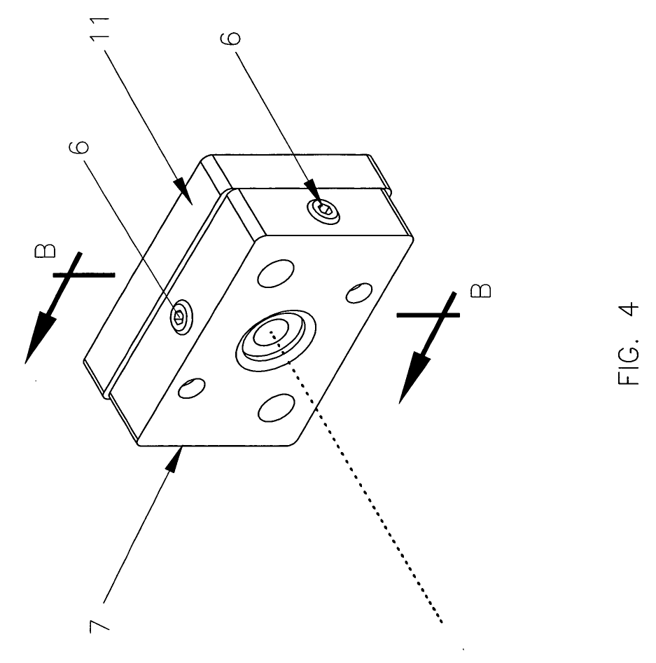

Referring to FIGS. 4 and 5, four holes are preferably drilled and tapped into the sides of the nozzle cover 7 at right angles to each other. Four screws 6 are preferably threaded into those holes and make contact with the nozzle 9.

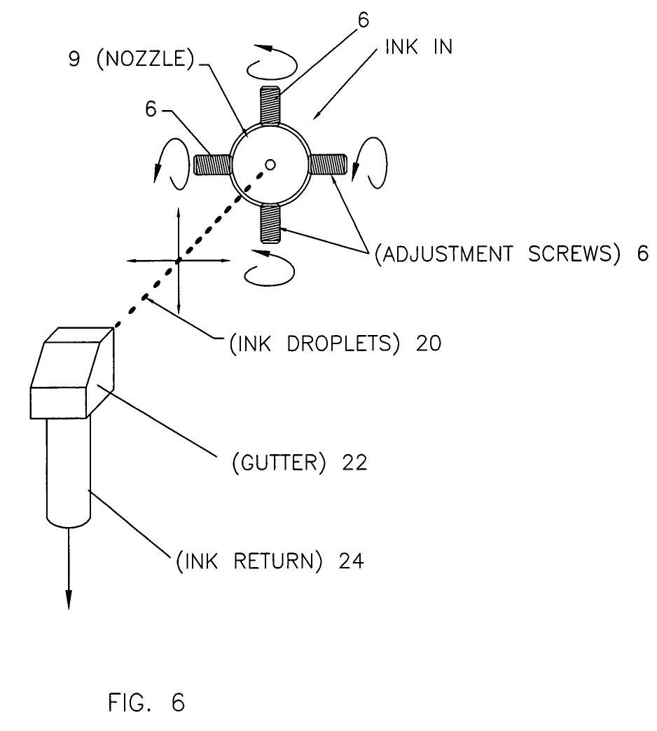

Adjustment of the nozzle in a desired direction is preferably accomplished by loosening a screw 6 on the same side that the stream of ink droplets is to be adjusted or moved and tightening the screw 6 on the opposite side until resistance is met from the loosening screws. This pushes the nozzle in the direction of travel of the tightening screw. By thusly using a combination of the four adjusting screws, the nozzle can be selectively translated in either or both of a “north-south” and “east-west” direction. FIG. 6 illustrates this arrangement schematically, whereby a stream of ink droplets 20 is directed to a gutter 22 and return tube 24. The countersink or chamfer of the hole at the boss end of the nozzle body 9 (as shown in FIG. 3) allows the misalignment of the hole in the center of the nozzle with the hole in the center of the nozzle back plate with out blocking or reducing ink flow where the two holes meet. Once adjustment is completed, the four screws 6 should be checked to insure they are tight, thereby locking the nozzle into position and preventing accidental movement.

It will be appreciated from the foregoing that among the advantages provided, in accordance with at least one presently preferred embodiment of the present invention, is a simple method of precisely adjusting an ink jet print head nozzle. There is further provided:

a locking mechanism for the nozzle once it is adjusted;

a tamper resistant design to discourage adjustment by unauthorized personnel;

the capability of factory alignment of the nozzle assembly, which can be later installed in machines in the field without further adjustment;

a compact design minimizing the space occupied in a print head;

a simplicity of assembly with a reduced number of parts;

elimination of soldering and welding;

a robust design not subject to misalignment due to physical or other environmental forces; and

a simple sealing method so that the nozzle can be aligned without leaking.

In brief recapitulation, the present invention, in accordance with at least one presently preferred embodiment, broadly embraces a nozzle assembly with an alignment adjustment mechanism to control the position of an ink jet stream issuing from the nozzle. The nozzle preferably comprises a small disc with an orifice and is made of a wear resistant material such as sapphire or ruby. The nozzle can be mounted and secured in a larger disk. A sealing ring made of an elastomer preferably fits over a boss on the opposite side of the disk. This assembly is installed in a plate with a counterbore larger in diameter than the nozzle disk assembly so that there is a gap between the circumference of the counterbore and the nozzle disk assembly. This permits the nozzle assembly to translate in any direction along a plane within the counterbore.

Another plate can be mounted to the counterbored side of the first plate, to thereby sandwich the nozzle disk in between. A hole is preferably drilled in the center of the plate, allowing fluid under pressure from the print head base to pass through to the nozzle disk. The counterbored plate also preferably has a hole drilled in the center through which the stream of ink issuing from the nozzle can pass. The sealing ring mounted on the boss of the nozzle disk prevents ink from leaking. The two plates are preferably fastened together with screws, with four screws preferably being threaded into the sides of the counter bored plate at right angles to each other. These screws are threaded through the wall of the counterbore and press up against the nozzle disk. The screws are used to move the nozzle disk in four directions, i.e., “north”, “south”, “east” and “west” with respect to the disk's plane of translational movement. This permits the stream of ink to be steered and aligned with a “gutter” and return line. The adjustment screws all preferably make contact with the nozzle disk so that once alignment has been achieved the disk cannot accidentally move out of position. Screws are preferably also used to attach the nozzle assembly to the print head base with a sealing o-ring in between. Though the possibility of moving a nozzle disk in four “cardinal” directions, which are orthogonal to one another, has been discussed, it is of course possible to utilize another arrangement where a nozzle disk (or the like) translates along a different set of directions. For instance, adjustment screws (or the like) could be placed in three mutually opposing pairs to provide three lines of travel that successively offset at about 60 degrees with respect to one another, or adjustment screws (or the like) could be placed in four mutually opposing pairs to provide four lines of travel that successively offset at about 45 degrees with respect to one another.

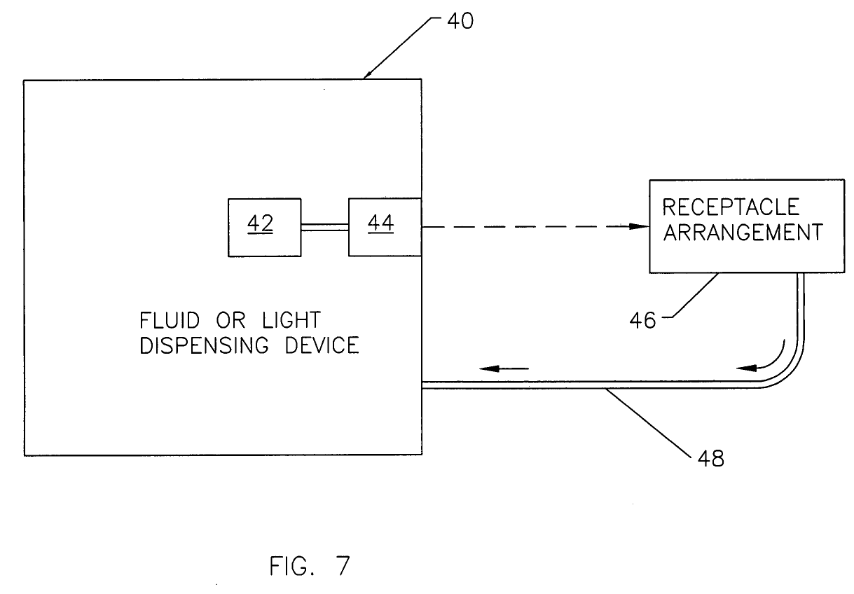

FIG. 7 schematically illustrates a general arrangement for positionally adjusting a continuous stream of fluid or light (such as laser light). As shown, a fluid or light dispensing device 40 may include a nozzle (or, alternatively, in the case of light, a light admission aperture arrangement) 44 and an arrangement for positionally adjusting the nozzle (or aperture arrangement) 42. In a preferred embodiment of the present invention, components 42 and 44 may essentially be configured and disposed in a manner similar to that described hereinabove with relation to FIGS. 1-6. The stream of fluid or light is directed to a target which, in accordance with at least one presently preferred embodiment of the present invention, may be embodied generally by a receptacle arrangement 46 (inasmuch as an intervening substrate or other material does not intercept this stream), and—at least in the case of ink or fluid—return ink/fluid may progress through a conduit arrangement 46 back to the dispensing device 40. Essentially any type of fluid or light stream may be provided or utilized. Examples are wide and varied, and may include (while by no means being limited to): provision of a water stream for high-pressure engraving or cutting; provision of an air or water stream for sandblasting; a plasma welding application, involving a plasma stream; a laser/shutter arrangement; and a mask/lens arrangement as employed in the semiconductor industry.

It should be understood and appreciated that the arrangements and embodiments discussed and contemplated hereinabove need not be restricted to settings and environments in which a gutter and/or return line is present, nor to settings and environments in which a continuous ink stream (or other fluid stream) is employed. Indeed, for instance, it is conceivable for embodiments of the present invention to be employed in an environment in which ink, fluid or light is oriented towards a general target, as opposed merely to a gutter (with or without a return line) in particular. It is also conceivable for embodiments of the present invention to involve ink, fluid or light streams that are not necessarily continuous in nature but, for instance, propagated in a series of disconnected pulses.

It should be understood and appreciated that whereas nozzles and aperture arrangements as discussed hereinabove have been presented (at least in places) as including just a single orifice or aperture for admitting and directing ink, fluid or light, it is of course possible to provide more than one orifice or aperture for admitting and directing ink, fluid or light. Thus, for instance, an orifice disk 10 as shown in FIGS. 3b and 3c may include 2, 3 or more orifices as opposed to just one orifice 10a as shown.

Without further analysis, the foregoing will so fully reveal the gist of the present invention and its embodiments that others can, by applying current knowledge, readily adapt it for various applications without omitting features that, from the standpoint of prior art, fairly constitute characteristics of the generic or specific aspects of the present invention and its embodiments.

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, any and all patents, patent publications, articles and other printed publications discussed or mentioned herein are hereby incorporated by reference as if set forth in their entirety herein. U.S. Provisional Patent Application Ser. No. 60/581,096 (from which the instant application claims priority), filed on Jun. 18, 2004, is hereby incorporated by reference as if set forth in its entirety herein.

It should be appreciated that the apparatus and method of the present invention may be configured and conducted as appropriate for any context at hand. The embodiments described above are to be considered in all respects only as illustrative and not restrictive. All changes which come within the meaning and range of equivalency of the claims are to be embraced within their scope.

1. In a fluid delivery arrangement according to claim 13, wherein:
said nozzle is configured to direct an output of ink; and
said arrangement for positionally adjusting said nozzle is adapted to positionally alter the output of ink.

2-11. (canceled)

12. In an ink delivery arrangement according to claim 1, wherein said ink delivery arrangement comprises a continuous ink jet printing arrangement.

13. In a fluid delivery arrangement, a nozzle assembly comprising:
a nozzle mounting arrangement;
a nozzle associated with said nozzle mounting arrangement, said nozzle being configured to direct an output of fluid; and
an arrangement for positionally adjusting said nozzle to positionally alter the output of fluid.

14. In a fluid delivery arrangement according to claim 13, wherein said arrangement for positionally adjusting is adapted to positionally adjust said nozzle relative to said nozzle mounting arrangement.

15. In a fluid delivery arrangement according to claim 13, wherein said arrangement for positionally adjusting is adapted to positionally alter the propagation of fluid towards a receptacle arrangement.

16. In a fluid delivery arrangement according to claim 15, wherein the receptacle arrangement comprises a gutter and return line.

17. In a fluid delivery arrangement according to claim 13, wherein said arrangement for positionally adjusting is adapted to maintain said nozzle in a fixed position.

18. In a fluid delivery arrangement according to claim 13, wherein said arrangement for positionally adjusting comprises a plurality of adjustment media each adapted to translate said nozzle in a predetermined direction.

19. In a fluid delivery arrangement according to claim 18, wherein said adjustment media comprise adjustment screws.

20. In a fluid delivery arrangement according to claim 18, wherein said adjustment media comprise two opposing pairs of adjustment media.

21. In a fluid delivery arrangement according to claim 18, wherein said adjustment media are adapted to selectably translate said nozzle along either of two lines of travel that are substantially orthogonal to one another.

22. In a fluid delivery arrangement according to claim 13, wherein said nozzle comprises an orifice holder and a fluid leak seal containing said orifice holder.

23. In a fluid delivery arrangement according to claim 22, wherein said orifice holder and fluid leak seal are disposed between a front plate and back plate.

24. In a fluid delivery arrangement according to claim 13, wherein the fluid comprises water.

25. The fluid delivery arrangement according to claim 26, wherein:
said fluid source comprises an ink source for providing ink;
said nozzle assembly being operably connected with said ink source and being adapted to accept ink provided by said ink source;
said nozzle being configured to direct an output of ink; and
said arrangement for positionally adjusting said nozzle being adapted to positionally alter the output of ink.

26. A fluid delivery arrangement comprising:
a fluid source for providing fluid;
a nozzle assembly operably connected with said fluid source and adapted to accept fluid provided by said fluid source; and
said nozzle assembly comprising:
a nozzle mounting arrangement;
a nozzle associated with said nozzle mounting arrangement, said nozzle being configured to direct an output of fluid; and
an arrangement for positionally adjusting said nozzle to positionally alter the output of fluid.

27. The fluid delivery arrangement according to claim 26, wherein the fluid comprises water.

28. The method according to claim 36, wherein:
said step of providing a nozzle comprises providing a nozzle configured for directing an output of ink; and
said step of positionally adjusting the nozzle comprises positionally adjusting the nozzle to positionally alter the output of ink.

29. The method according to claim 28, wherein said adjusting step comprises positionally adjusting the nozzle relative to a nozzle mounting arrangement.

30. The method according to claim 28, wherein said adjusting step comprises positionally altering the propagation of ink towards a receptacle arrangement.

31. The method according to claim 28, further comprising the step of maintaining the nozzle in a fixed position subsequent to said adjusting step.

32. The method according to claim 28, wherein said adjusting step comprises selectably translating the nozzle along one of at least two lines of travel

33. The method according to claim 32, wherein said adjusting step further comprises selectably translating the nozzle in one of two opposite directions along one of at least two lines of travel.

34. The method according to claim 32, wherein the two lines of travel that are substantially orthogonal to one another.

35. The method according to claim 28, wherein said method is performed in a continuous ink jet printing arrangement.

36. A method of delivering fluid, said method comprising the steps of:
providing a nozzle configured for directing an output of fluid; and
positionally adjusting the nozzle to positionally alter the output of fluid.

37. In a light provision arrangement, an aperture assembly comprising:
an arrangement for mounting a light admission aperture;
a light admission aperture associated with said mounting arrangement, said light admission aperture being configured to direct an output of light; and
an arrangement for positionally adjusting said light admission aperture to positionally alter the output of light.

38. In a light provision arrangement according to claim 37, wherein the light comprises laser light.
